(19) United States
(12) Patent Application Publication
(10) Pub. No.: US 2014/0289282 A1
(43) Pub. Date: Sep. 25, 2014

(54) DECODING DEVICE AND COMPUTER PROGRAM PRODUCT

(71) Applicant: KABUSHIKI KAISHA TOSHIBA, Tokyo (JP)

(72) Inventors: Yumiko SAKAI, Kawasaki-shi (JP); Yusuke DOI, Yokohama-shi (JP)

(73) Assignee: KABUSHIKI KAISHA TOSHIBA, Tokyo (JP)

(21) Appl. No.: 14/146,856

(22) Filed: Jan. 3, 2014

(30) Foreign Application Priority Data
Mar. 22, 2013 (JP) 2013-060587

(51) Int. Cl. G06F 17/30

(52) U.S. Cl. CPC G06F 17/30914
USPC 707/803

(57) ABSTRACT

According to an embodiment, a decoding device includes: a holding unit including a first level cache to hold a result of decoding binary data into a structured document by a decoder with the binary data, and a second level cache to hold partial data pieces into which the binary data is divided in predetermined units of events of the structured document and the result of decoding corresponding to the partial data pieces; and a retention determiner to divide the binary data in the predetermined units of events, and store the partial data pieces and the result of decoding corresponding to the partial data pieces into the second level cache. When the binary data that is input includes a part matching a partial data piece held by the second level cache in the predetermined units of events, the decoding unit outputs the decoding result corresponding to the matching partial data piece.

### CROSS-REFERENCE TO RELATED APPLICATION(S)

This application is based upon and claims the benefit of priority from Japanese Patent Application No. 2013-060587, filed on Mar. 22, 2013; the entire contents of which are incorporated herein by reference.

### FIELD

Embodiments described herein relate generally to a decoding device and a computer program product.

### BACKGROUND

There has been an increasing trend in the data amount of structured documents in XML and the like, and the structured documents are thus not suitable for high-speed data processing and processing handling a large amount of XML documents. Efficient XML Interchange (EXI) is therefore proposed as a standard for efficient and high-speed data processing. The EXI converts an XML document to an EXI stream that is a binarized representation according to the XML schema. This can contribute to efficient data communication and processing since binarized data are dramatically reduced in data volume.

Furthermore, for actually checking data binarized as described above by a user, the user inputs the EXI stream to a decoding device having the same logic as that of a state machine used to binarize the XML document, and the original XML document is output therefrom. Since the output XML document is written in a natural language, the user can thus check the content thereof.

The EXI stream is encoded or decoded bit-by-bit. Typically, reading and writing of data bit-by-bit cause heavy loads and tend to decrease the processing speed. When a decoding device installed in a server that receives all EXI streams output from numerous devices or a decoding device installed in a low-processing-speed device is assumed, processing by reading and writing data bit-by-bit may not be fast enough.

### BRIEF DESCRIPTION OF THE DRAWINGS

FIG. 1 is a general view according to a first embodiment;

FIG. 2 is a block diagram illustrating details of a functional configuration of a smart meter according to the first embodiment;

FIG. 3 is a block diagram illustrating details of a functional configuration of a decoder according to the first embodiment;

FIG. 4 is a flowchart illustrating a flow of processing performed by an EXI stream decoding unit according to the first embodiment;

FIG. 5 illustrates an example of data held by a holding unit according to the first embodiment;

FIG. 6 illustrates an example of data retention of the holding unit according to the first embodiment;

FIG. 7 is a flowchart illustrating a flow of processing performed by a retention determining unit according to the first embodiment;

FIG. 8 is a general view according to a second embodiment;

FIG. 9 is a block diagram illustrating details of a functional configuration of a home server according to the second embodiment;

FIG. 10 is a block diagram illustrating details of a functional configuration of a decoder according to the second embodiment;

FIG. 11 illustrates an example of data retention of a holding unit according to the second embodiment; and

FIG. 12 is a flowchart illustrating a flow of processing performed by a retention determining unit according to the second embodiment.

### DETAILED DESCRIPTION

According to an embodiment, a decoding device includes a decoder, a holding unit, and a retention determiner. The decoder decodes binary data into a structured document according to a state machine that has been used to convert the structured document into binary data. The holding unit includes a first level cache and a second level cache. The first level cache holds a result of decoding the binary data into the structured document by the decoding unit with the binary data. The second level cache holds partial data pieces into which the binary data held by the first level cache is divided in predetermined units of events of the structured document and the result of decoding that corresponds to the partial data pieces. The retention determiner generates the partial data pieces by dividing the binary data held by the first level cache in the predetermined units of events, and storing the generated partial data pieces and the result of decoding corresponding to the partial data pieces into the second level cache. When the binary data that is input includes a part matching a partial data piece held by the second level cache in the predetermined units of events, the decoding unit outputs the result of decoding corresponding to the matching partial data piece held by the second level cache.

### First Embodiment

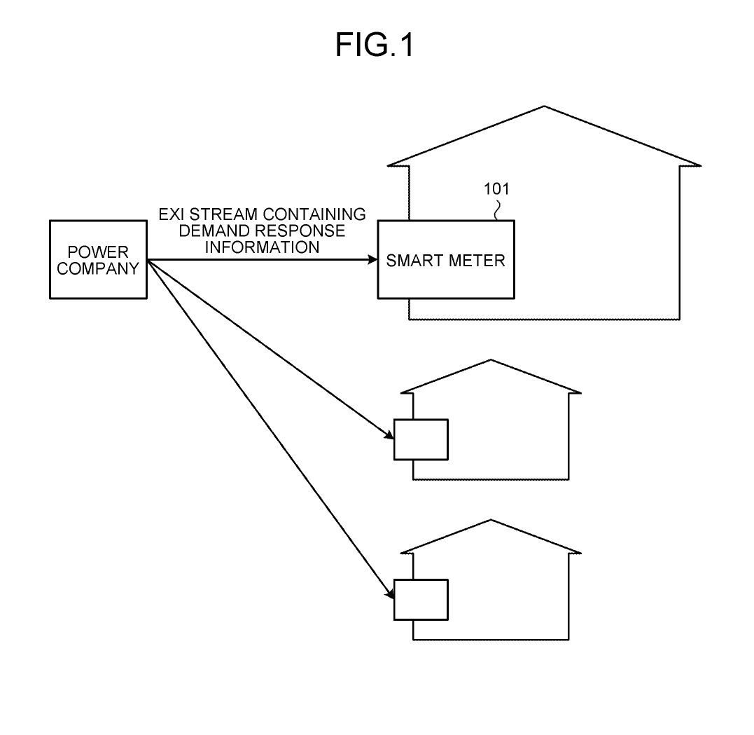

An embodiment in which a decoding device is embodied as a smart meter will be described below. FIG. 1 is a diagram illustrating a scene in which a smart meter 101 is used. As illustrated in FIG. 1, a case in which an EXI stream that is information on a demand for reducing power consumption (demand response) is distributed to consumers such as homes from a supplier such as a power company is assumed. The EXI stream is received by a smart meter 101. Note that the decoding device can also be used for other applications, and can be applied as appropriate to any system in which EXI streams are transmitted and decoded from binary data into normal XML document data.

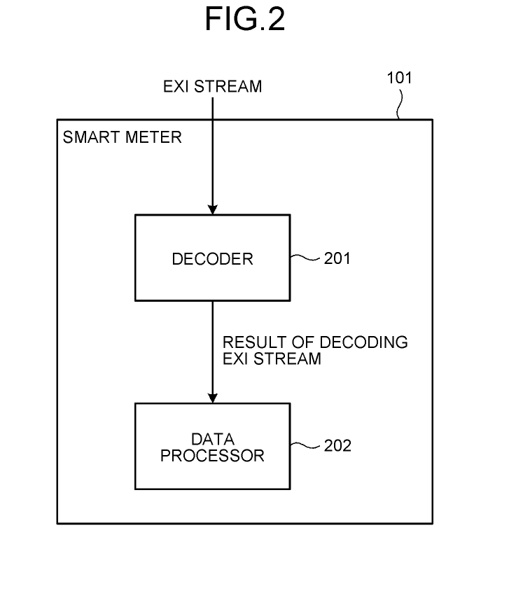

FIG. 2 is a block diagram illustrating a functional configuration of the smart meter 101. The smart meter 101 includes a decoder 201 and a data processor 202. The decoder 201 and the data processor 202 may be implemented by software, may be implemented by hardware, or may be implemented by combination thereof. The decoder 201 decodes an input EXI stream and outputs the decoding result. The data processor 202 processes the decoded data. Examples of processing performed by the data processor 202 include generating control instructions to home electric appliances connected to the smart meter 101, and transmitting such control instructions.

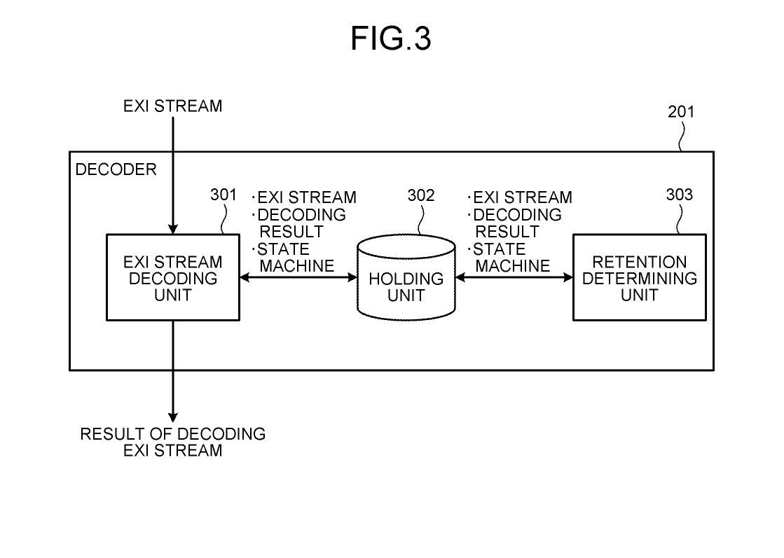

FIG. 3 is a configuration diagram of the decoder 201. The decoder 201 includes an EXI stream decoding unit 301, a holding unit 302, and a retention determining unit 303. The EXI stream decoding unit 301 decodes an EXI stream with reference to the holding unit 302. The EXI stream decoding unit 301 has the same state machine as that used for converting an EXI stream to binary data. Furthermore, the EXI stream decoding unit 301 stores an EXI stream, a decoding result, and a state machine into the holding unit 302. The holding unit 302 holds a result of decoding by the EXI stream decoding unit. The holding unit 302 is a nonvolatile storage medium such as an HDD or a RAM. The retention determining unit 303 selects decoding results that meet a condition, which will be described later, from decoding results held by the holding unit 302 when the smart meter 101 is in an idle state in which, for example, the CPU usage is 20% or lower.

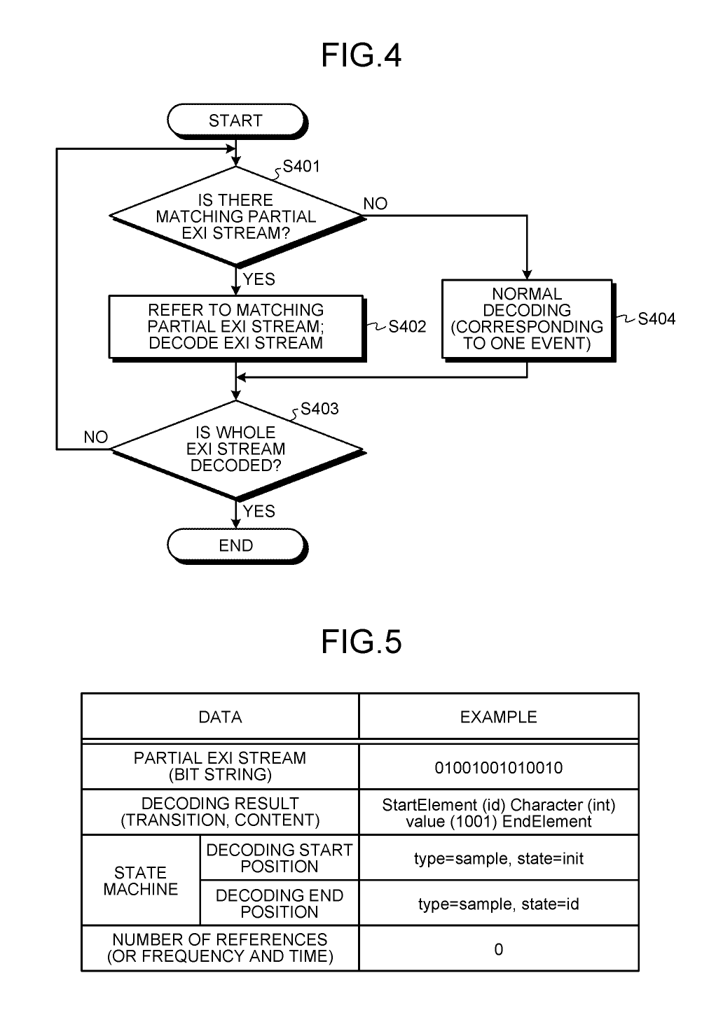

FIG. 4 is a flowchart illustrating a flow of processing performed by the EXI stream decoding unit 301. An EXI stream is decoded starting from head binary data on the basis of the current state of the state machine of the EXI stream decoding unit 301. First, the EXI stream decoding unit 301 searches whether there is a partial EXI stream having a state matching the state corresponding to a decoding start position of an EXI stream to be decoded in the holding unit 302 (step S401).

The method of the search is as follows. First, it is searched whether or not there is a partial EXI stream having a state matching the current state of the state machine of the EXI stream decoding unit 301. If there is a matching partial EXI stream, binary data constituting the partial EXI stream and the received binary data are compared, and it is determined that there is a matching partial EXI stream if the binary data match each other in all bits. A partial EXI stream is binary data of part of an EXI stream extracted from the EXI stream. Partial EXI streams are obtained by dividing an EXI stream held by the holding unit 302 in predetermined units of events. The unit of events is the data width of a code corresponding to transition of the state machine used for binarization and decoding of a structured document or the data width of a content of the structured document.

If there is a matching partial EXI stream in a second level cache of the holding unit 302 (step S401: Yes), the EXI stream decoding unit 301 skips the decoding process for the partial EXI stream, uses the decoding result held by the holding unit 302, and resumes decoding of the remaining EXI stream from a state corresponding to a decoding end position (step S402). If there is no matching partial EXI stream (step S401: No), the EXI stream decoding unit 301 performs normal decoding (step S404). The EXI stream decoding unit 301 then determines whether or not decoding of the whole EXI stream is completed (step S403), and terminates the process if completed.

FIG. 5 illustrates an example of data held by the second level cache of the holding unit 302. The held data contains a bit string of a partial EXI stream, a decoding result, a position (start point) of a state machine corresponding to the beginning of the partial EXI stream, a position (end point) of the state machine corresponding to the end, and the number of references. The partial EXI stream is a bit string, the decoding result includes a transition process and a content, the state machine includes the positions of the state machine corresponding to the start and the end of the partial EXI stream, type represents the name of the state machine, and state represents the name of the state. Furthermore, the number of references (counts), the frequency or the time is recorded in the data referred to by the EXI stream decoding unit 301. The number of references refers to the number of times the EXI stream decoding unit 301 used the partial EXI stream for decoding the binary data.

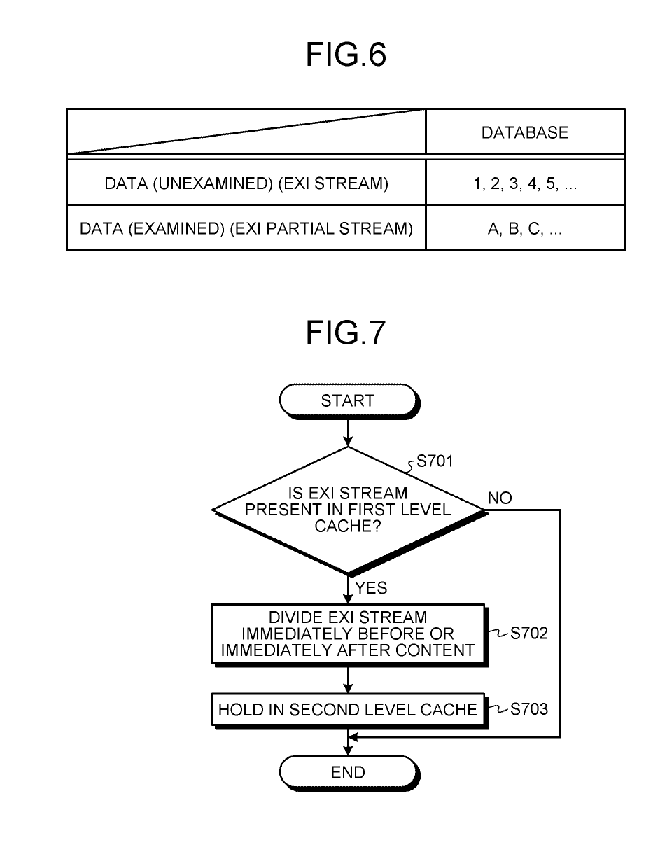

FIG. 6 illustrates an example of data retention of the holding unit 302. Data are held separately in a first level cache holding unexamined data and the second level cache holding examined data. The data referred to by the EXI stream decoding unit 301 is examined data stored in the second level cache. When the remaining capacity of the second level cache becomes lower than a predetermined threshold, the use time is referred to and most recently used data is deleted by using a cache algorithm such as MRU (Most Recently Used). Examples of other cache algorithms include a Least Recently Used scheme that discards least recently used data, the MRU scheme that discards the most recently used data, a Pseudo-LRU scheme that stochastically discards substantially least recently used data, a Least Frequently Used scheme that holds the frequency of use of each data piece and discards least frequently used data, and an Adaptive Replacement Cache scheme that balances between the LRU scheme and the LFU scheme to obtain an optimal result.

FIG. 7 is a flowchart illustrating a flow of processing performed by the retention determining unit 303. The retention determining unit 303 refers to the unexamined data in the first level cache of the holding unit 302, and determines whether or not an EXI stream is present in the first level cache (step S701). If it is determined that an EXI stream is present in the first level cache (step S701: Yes), the retention determining unit 303 divides the EXI stream immediately before or immediately after a content by referring to the decoding result (step S702). The retention determining unit 303 then holds each partial EXI stream obtained by the division as examined data with position information of the state machine corresponding to the start and the end of the partial EXI stream in the second level cache (step S703). A threshold for the length of a partial EXI stream to be held may be set to determine whether or not to hold a partial EXI stream. If, on the other hand, it is determined that no EXI stream is present in the first level cache (step S701: No), the processing is terminated here.

Next, decoding of an EXI stream “1000 0000 1000 0000 1000 0000” will be described first and decoding of an EXI stream “1000 0000 1000 0000 1100 0000” will then be described. Since there is no data in the holding unit 302 when a first EXI stream is to be decoded, the EXI stream decoding unit 301 performs normal decoding from the start to the end according to the decoding rule.

If an XML document obtained by decoding “1000 0000 1000 0000 1000 0000” is:

### <A>

<B>0</B>

### </A>,

the event and the content that are the decoding result will be:

StartElement(A) StartElement(B) Character(Boolean) Value(0) EndElement EndElement EndDocument.

The EXI stream decoding unit 301 provides the EXI stream and the decoding result with the information on the state machine for the decoding rule having events as transitions to the holding unit 302. The holding unit 302 holds the information in the first level cache. The retention determining unit 303 checks whether data is present in the holding unit 302 at predetermined timing. At this point, data is present only in the first level cache.

The retention determining unit 303 divides the data held in the first level cache into two partial EXI streams as follows:

Partial EXI stream: 10000000100000001

Decoding result: StartElement(A) StartElement(B) Character(Boolean)

Start position: Type=Document, State=init

End position: Type=B, State=Term1

Number of references: 0

Partial EXI stream: 0000000

Decoding result: Value(0) EndElement EndElement EndDocument

Start position: Type=B, State=Term1

End position: Type=Document, State=Term2

Number of references: 0.

The retention determining unit 303 then holds the two partial EXI streams obtained by the division in the second level cache of the holding unit 302. In this case, the data obtained by the division may overlap in such a manner as:

StartElement(A) StartElement(B) Character(Boolean) StartElement(B) Character(Boolean).

If the number of data pieces to be held is to be limited, such a condition that a partial EXI stream having a length equal to or shorter than a threshold is not held may be provided. In this case, since the processing load of decoding a short partial EXI stream is not very heavy, the capacity of the second level cache can be reduced while maintaining the processing efficiency. It is assumed here that there is no second data to be held. “Type”, “State” and the values of the start position and the end position are names used to represent the positions of the state machine for the decoding rule, and any names may be used as long as the positions can be provided. The condition for the division is immediately before a content.

Subsequently, the EXI stream decoding unit 301 decodes the second EXI stream. The EXI stream decoding unit 301 searches whether or not data matching the current decoding position (the EXI stream and the state machine for the decoding rule) is present in the second level cache of the holding unit 302. Out of the second EXI stream “1000 0000 1000 0000 1100 0000”, data up to “1000 0000 1000 0000 1” matches.

The EXI stream decoding unit 301 thus refers to data:

Partial EXI stream: 10000000100000001

Decoding result: StartElement(A) StartElement(B) Character(Boolean)

Start position: Type=Document, State=init

End position: Type=B, State=Term1

Number of references: 0

as matching data in the second level cache and obtains the data as the decoding result.

Subsequently, since there is no decoded partial EXI stream corresponding to the remaining EXI stream “1000000” in the second level cache, the EXI stream decoding unit 301 decodes the remaining EXI stream from the end position.

If the event and the content of the result of decoding the remaining EXI stream “1000000” is:

Value(1) EndElement EndElement EndDocument, the entire decoding result including the referred data will be:

StartElement(A) StartElement(B) Character(Boolean) Value(1) EndElement EndElement EndDocument.

With the decoding device according to the present embodiment as described above, a result of decoding a partial EXI stream is used for decoding an EXI stream if a decoded partial EXI stream having the same bits is present, which allows redundant processing in decoding to be skipped. It is therefore possible to decode an EXI stream more efficiently.

### Second Embodiment

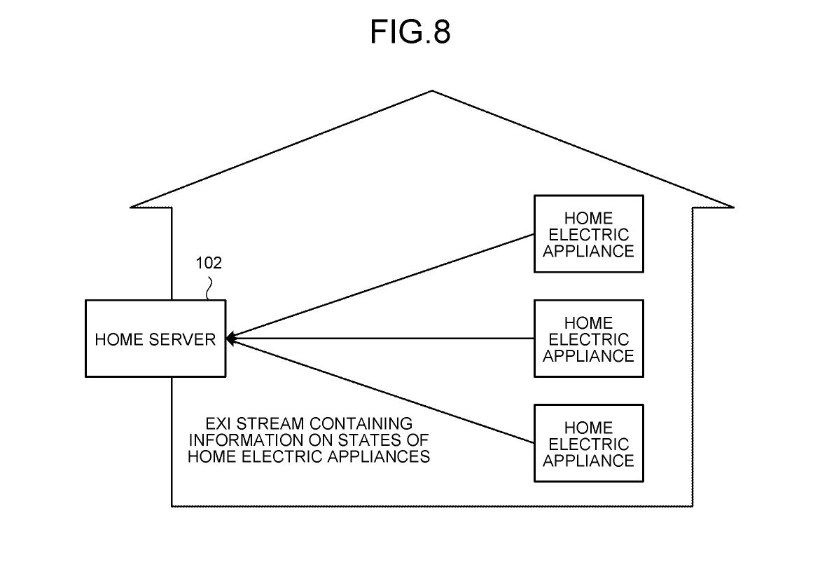

Next, an embodiment in which a decoding device is installed as a home server 102 will be described. FIG. 8 is a general view illustrating a state in which the home server 102 is used. The home server 102 is configured to monitor the states of home electric appliances so as to control the home electric appliances to reduce power consumption, and receives information on the states of the home electric appliances as an EXI stream.

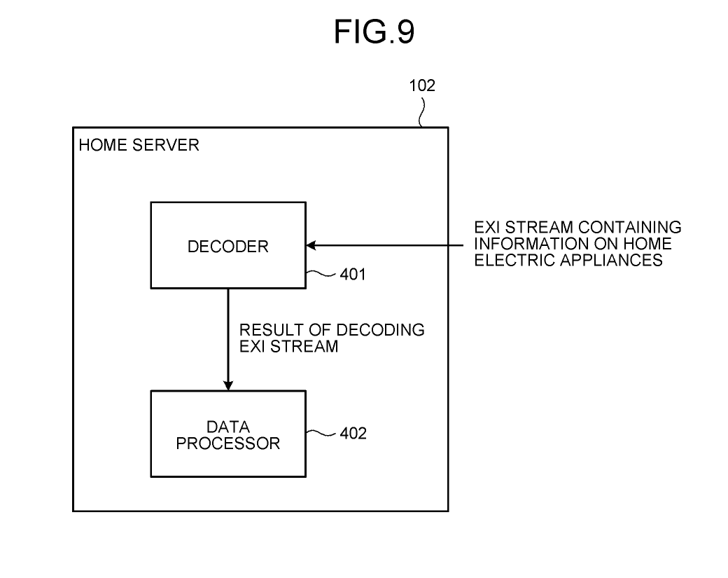

FIG. 9 is a block diagram illustrating the functional configuration of the home server 102. The home server 102 includes a decoder 401 and a data processor 402. The decoder 401 decodes an input EXI stream and outputs the decoding result. The data processor 402 processes the decoded data. Examples of processing performed by the data processor 402 include generating control instructions to home electric appliances connected to the home server 102, and transmitting such control instructions.

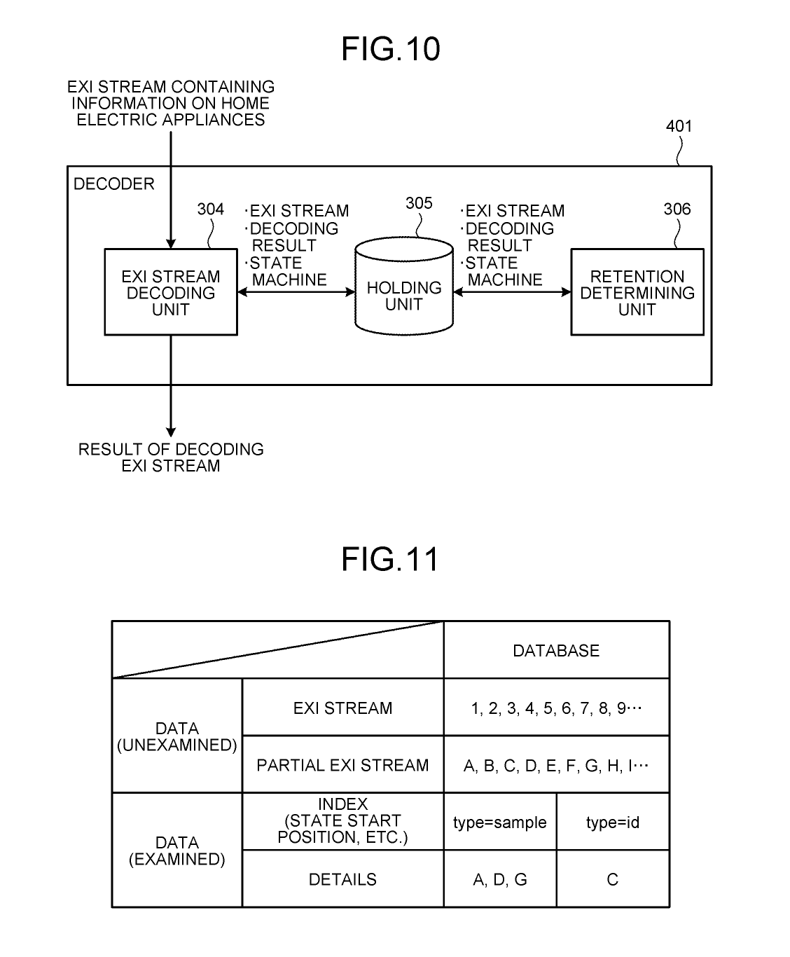

FIG. 10 is a block diagram illustrating the functional configuration of the decoder 401. The configuration and the operation of the decoder 401 are the same as those of the decoder 201. Furthermore, the operation of an EXI stream decoding unit 304 is the same as that of the EXI stream decoding unit 301.

FIG. 11 is a table illustrating an example of a state of data retention of a holding unit 305. Similarly to the holding unit 302, data are held separately in a first level cache holding unexamined data and the second level cache holding examined data, and data that is referred to is data in the second level cache. There are the following two differences from the holding unit 302. When an EXI stream is divided into partial EXI streams, data are not held in the second level cache and are thus held in the state of the EXI stream and in the state of the partial EXI streams in the first level cache. In addition, an index is added so that the EXI stream decoding unit 304 can easily refer to data. The index may be a state machine that is the start position or the like. If data exceed the capacity of a cache, the least frequently used data are deleted by referring to the frequency of use and using a cache algorithm such as LFU (Least Frequently Used).

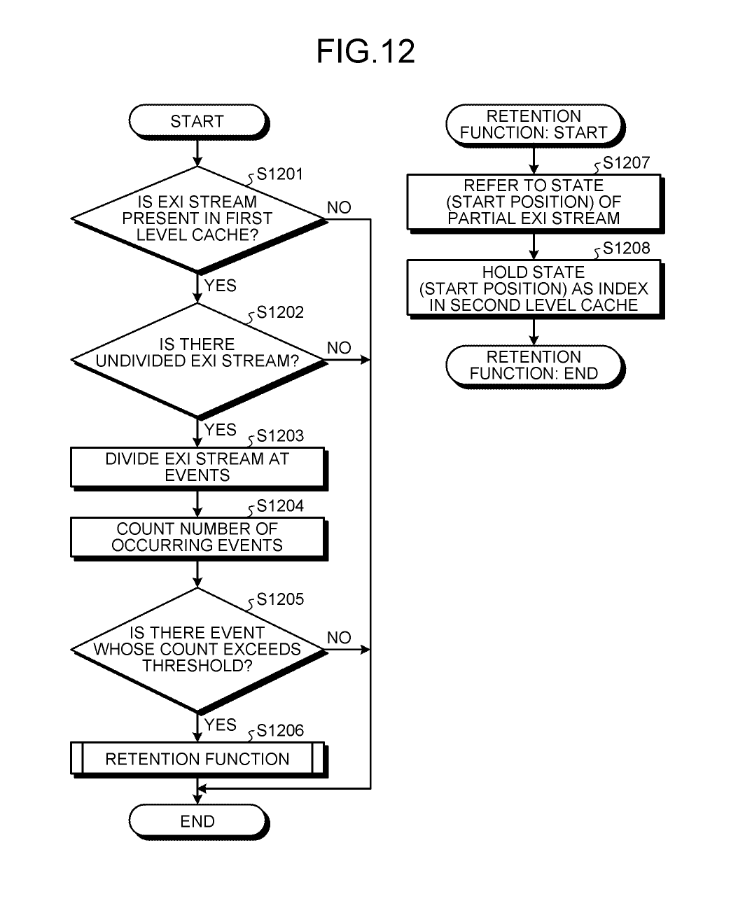

FIG. 12 is a flowchart illustrating a flow of processing performed by the retention determining unit 306. The retention determining unit 306 first determines whether or not an EXI stream is present in the first level cache (step S1201). If it is determined that no EXI stream is present (step S1201: No), the processing is terminated here. If, on the other hand, it is determined that an EXI stream is present in the first level cache (step S1201: Yes), the retention determining unit 306 determines whether or not there is an undivided EXI stream (step S1202). If it is determined that there is no undivided EXI stream (step S1202: No), the processing is terminated. If, on the other hand, it is determined that there is an undivided EXI stream (step S1202: Yes), the retention determining unit 306 divides unexamined data in the holding unit 305 at events into pieces having appropriate lengths (step S1203). The retention determining unit 306 also counts the number of occurring events by referring to the decoding result for the division (step S1204). The retention determining unit 306 determines whether or not the count exceeds a predetermined threshold (step S1205). If the count is equal to or larger than the threshold (step S1205: Yes), the retention determining unit 306 calls a retention function for holding a partial EXI stream containing the state (start position) in the second level cache (step S1206). According to the retention function, the retention determining unit 306 first refers to the state (start position) of the partial EXI stream (step S1207). The retention determining unit 306 then holds the partial EXI stream with the state (start position) as an index in the second level cache (step S1208).

Specifically, it is assumed that the results of decoding three EXI streams:

100000001000000010000000

100000010000000010000000

1000000010000000100000001000000011000000

are:

StartElement(A) StartElement(B) Character(Boolean) Value(0) EndElement EndElement EndDocument

StartElement(A) StartElement(C) Character(Boolean) Value(0) EndElement EndElement EndDocument

StartElement(A) StartElement(B) Character(Boolean) Value(0) EndElement StartElement(B) Character(Boolean) Value(1) EndElement EndElement EndDocument.

In this case, the state corresponding to <B> </B> in an XML document occurs three times. If the threshold is three, partial data containing this state out of the divided EXI stream is held in the second level cache. Alternatively, counting may be performed before dividing the EXI streams and the EXI streams may be divided according to the counting results.

According to the present embodiment, a partial EXI stream that frequently occurs is selectively held, which allows efficient decoding while reducing the cache capacity.

The decoding device according to the embodiments described above includes a control device such as a CPU, a storage device such as a read only memory (ROM) and a random access memory (RAM), an external storage device such as an HDD and a CD drive, a display device such as a display, and an input device such as a key board and a mouse, which is a hardware configuration utilizing a common computer system.

Programs to be executed by the decoding device according to the embodiments described above are recorded on a computer readable recording medium such as a CD-ROM, a flexible disk (FD), a CD-R, and a digital versatile disk (DVD) in a form of a file that can be installed or executed, and provided therefrom.

Alternatively, the programs in the embodiments described above may be stored on a computer system connected to a network such as the Internet, and provided by being downloaded via the network. Still alternatively, the programs to be executed by the decoding device according to the embodiments described above may be provided or distributed through a network such as the Internet. Still alternatively, the programs in the embodiments described above may be embedded on a ROM or the like in advance and provided therefrom.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A decoding device comprising:
a decoder configured to decode binary data into a structured document according to a state machine that has been used to convert the structured document into binary data;
a holding unit including a first level cache and a second level cache, the first level cache being configured to hold a result of decoding the binary data into the structured document by the decoder with the binary data, and the second level cache being configured to hold partial data pieces into which the binary data held by the first level cache is divided in predetermined units of events of the structured document and the result of decoding that corresponds to the partial data pieces; and
a retention determiner configured to generate the partial data pieces by dividing the binary data held by the first level cache in the predetermined units of events, and storing the generated partial data pieces and the result of decoding corresponding to the partial data pieces into the second level cache, wherein
when the binary data that is input includes a part matching a partial data piece held by the second level cache in the predetermined units of events, the decoder outputs the result of decoding corresponding to the matching partial data piece held by the second level cache.

2. The device according to claim 1, wherein the holding unit holds, in the second level cache, the partial data piece containing a data width of a code corresponding to transition of the state machine or a bit string that is part of the binary data obtained by dividing the binary data according to a data width of a content in the structured document, the result of decoding corresponding to the bit string, a state of the state machine corresponding to start of the bit string, and a state of the state machine corresponding to end of the bit string.

3. The device according to claim 1, wherein the retention determiner generates the partial data pieces by dividing the binary data held by the first level cache in units of events of the structured document, and sets the state of the state machine corresponding to the start of the bit string to be an index when holding the partial data pieces with the decoding result in the second level cache.

4. The device according to claim 1, wherein the retention determiner generates the partial data pieces by dividing the binary data held by the first level cache in such a way that a bit at a position immediately after a content is a start point and a bit at a position immediately before a content is an end point in the result of decoding, and holds the partial data pieces with the result of decoding, and position information containing the start points and the end points in the second level cache.

5. The device according to claim 1, wherein
the decoder stores a count obtained by counting the number of transitions between states of the state machine used to binarize the structured document and decoding the binary data in the first level cache when decoding the binary data, and
the retention determiner stores the partial data pieces whose count of the states is a predetermined threshold or larger in the second level cache.

6. The device according to claim 1, wherein the retention determiner prevents the holding unit from holding a partial data piece having a bit string that is smaller than a predetermined threshold.

7. The device according to claim 1, wherein the retention determiner stores the partial data pieces in the second level cache when the device is in an idle state.

8. The device according to claim 1, wherein the retention determiner deletes the partial data pieces by using a predetermined cache algorithm when a remaining capacity of the first level cache or the second level cache becomes less than a predetermined threshold.

9. A computer program product comprising a computer-readable medium containing a computer program that causes a computer to function as:
a decoder configured to decode binary data into a structured document according to a state machine that has been used to convert the structured document into binary data;
a holding unit including a first level cache configured to hold a result of decoding the binary data into the structured document by the decoder with the binary data, and a second level cache configured to hold partial data pieces into which the binary data held by the first level cache is divided in predetermined units of events of the structured document and the result of decoding that corresponds to the partial data pieces; and
a retention determiner configured to generate the partial data pieces by dividing the binary data held by the first level cache in the predetermined units of events, and storing the generated partial data pieces and the result of decoding corresponding to the partial data pieces into the second level cache, wherein
when the binary data that is input includes a part matching a partial data piece held by the second level cache in the predetermined units of events, the decoder outputs the decoding result corresponding to the matching partial data piece held by the second level cache.
